(19) United States
(12) Patent Application Publication
(10) Pub. No.: US 2022/0355688 A1
(43) Pub. Date: Nov. 10, 2022

(54) SMART STREET LAMP CHARGING SYSTEM

(71) Applicant: Cheng Uei Precision Industry Co., Ltd., New Taipei City (TW)

(72) Inventors: Kuo Yang Wu, New Taipei City (TW); Yu Yuan Wu, New Taipei City (TW); Hsi Chun Lee, New Taipei City (TW)

(21) Appl. No.: 17/715,106

(22) Filed: Apr. 7, 2022

Related U.S. Application Data
(60) Provisional application No. 63/183,854, filed on May 4, 2021.

(51) Int. Cl. B60L 53/31; B60L 53/12; H02J 50/00; H02J 50/90; H02J 50/40

(52) U.S. Cl. CPC B60L 53/31; B60L 53/12; H02J 50/005; H02J 50/90; H02J 50/40; F21S 8/085

(57) ABSTRACT

A smart street lamp charging system includes at least one street lamp module, at least one first charging device and a second charging device. The at least one street lamp module includes a light pole. The at least one first charging device is mounted to the light pole of the at least one street lamp module. The at least one first charging device includes a wireless transmitting module. The second charging device is mounted at a body of an electric vehicle. The second charging device includes a wireless receiving module. The wireless receiving module is able to receive energies from the wireless transmitting module to proceed with a wireless charging.

### CROSS-REFERENCE TO RELATED APPLICATION

This application claims the priorities of U.S. provisional patent application No. 63/183,854, filed on May 4, 2021, which is incorporated herewith by reference.

### BACKGROUND OF THE INVENTION

### 1. Field of the Invention

The present invention generally relates to a smart street lamp charging system, and more particularly to a smart street lamp charging system that is able to charge electric vehicles.

### 2. The Related Art

An existing electric vehicle needs charging at a few specific locations, or electric power which is required by the existing electric vehicle is provided by way of replacing batteries. However, this above-mentioned charging method requires that the existing electric vehicle enter the specific location, or the electric power is provided for the existing electric vehicle by an extra battery. Thus, when the existing electric vehicle is charged, the existing electric vehicle is caused to take an extra route or a negative weight.

Thus, it is necessary to provide an innovative smart street lamp charging system, the innovative smart street lamp charging system is able to conveniently and instantly provide an additional power supply for the electric vehicle to maintain an operation of the electric vehicle.

### SUMMARY OF THE INVENTION

An object of the present invention is to provide a smart street lamp charging system. The smart street lamp charging system includes at least one street lamp module, at least one first charging device and a second charging device. The at least one street lamp module includes a light pole. The at least one first charging device is mounted to the light pole of the at least one street lamp module. The at least one first charging device includes a wireless transmitting module. The second charging device is mounted at a body of an electric vehicle. The second charging device includes a wireless receiving module. The wireless receiving module is able to receive energies from the wireless transmitting module to proceed with a wireless charging.

Another object of the present invention is to provide a smart street lamp charging system. The smart street lamp charging system includes at least one street lamp module, at least one first charging device and a second charging device. The at least one street lamp module includes a light pole. The light pole includes a charging cable. The at least one first charging device is mounted to the at least one street lamp module. The at least one first charging device is connected with the charging cable. The second charging device is mounted at a body of an electric vehicle. The second charging device is able to connect with the charging cable, so electric energies of the at least one first charging device are transmitted to the second charging device through the charging cable.

Another object of the present invention is to provide a smart street lamp charging system. The smart street lamp charging system includes a plurality of street lamp modules, a plurality of first charging devices and a plurality of second charging devices. The plurality of the first charging devices are mounted under the plurality of the street lamp modules. The plurality of the first charging devices include a plurality of wireless transmitting modules. The plurality of the second charging devices are mounted at bodies of a plurality of electric vehicles. The plurality of the second charging devices include a plurality of wireless receiving modules. The plurality of the wireless receiving modules are able to receive energies from the plurality of the wireless transmitting modules. The plurality of the first charging devices are able to simultaneously charge the plurality of the second charging devices.

As described above, the smart street lamp charging system charges the second charging device mounted at the electric vehicle by virtue of the at least one first charging device being mounted to the at least one street lamp module, so that an instant charging of the electric vehicle is realized. As a result, the smart street lamp charging system is able to conveniently and instantly provide an additional power supply for the electric vehicle to maintain an operation of the electric vehicle.

### BRIEF DESCRIPTION OF THE DRAWINGS

The present invention will be apparent to those skilled in the art by reading the following description, with reference to the attached drawings, in which:

FIG. 1 is a schematic view of a smart street lamp charging system in accordance with a first preferred embodiment of the present invention;

FIG. 2 is a system block diagram of the smart street lamp charging system in accordance with the first preferred embodiment of the present invention; and

FIG. 3 is a schematic view of the smart street lamp charging system in accordance with a second preferred embodiment of the present invention.

### DETAILED DESCRIPTION OF THE PREFERRED EMBODIMENT

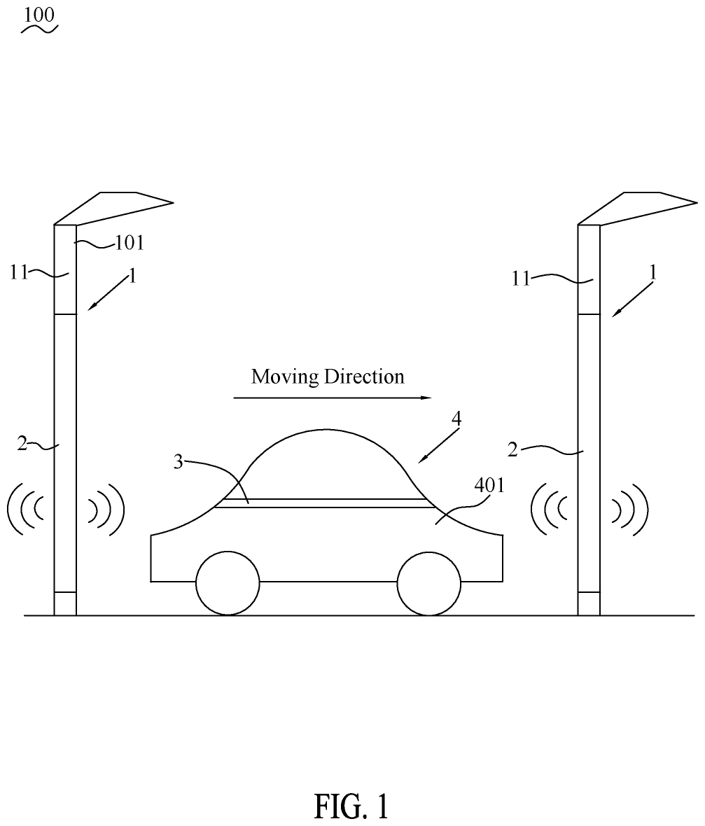

With reference to FIG. 1, a smart street lamp charging system 100 in accordance with a first preferred embodiment of the present invention is shown. The smart street lamp charging system 100 includes at least one street lamp module 1, at least one first charging device 2 and a second charging device 3. The at least one first charging device 2 is mounted to the at least one street lamp module 1. The second charging device 3 is mounted at a body 401 of an electric vehicle 4. The at least one first charging device 2 and the second charging device 3 are able to charge each other.

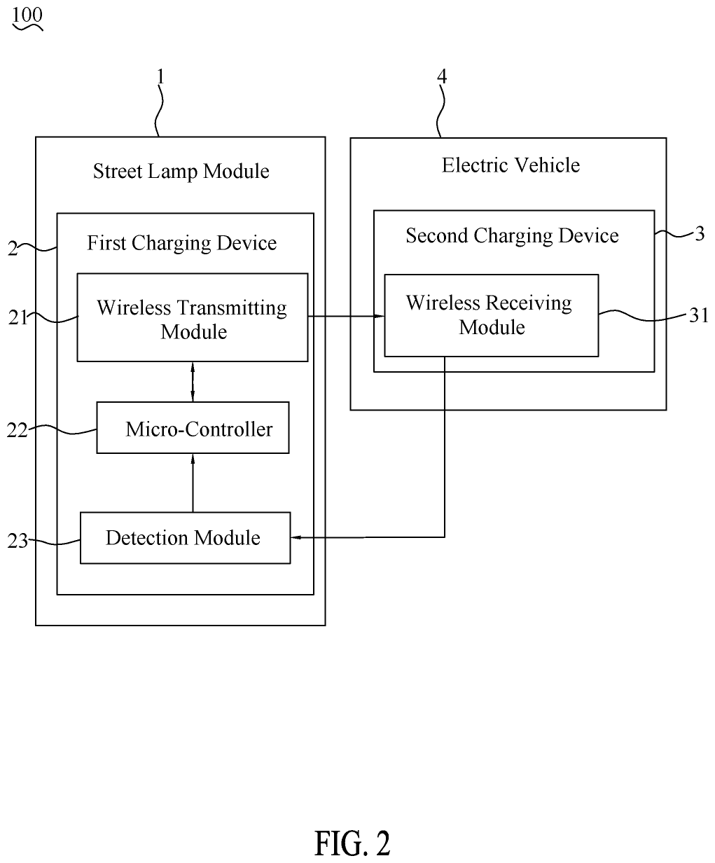

With reference to FIG. 1 and FIG. 2, in the first preferred embodiment, the at least one street lamp module 1 includes a light pole 11. The at least one first charging device 2 is mounted under the light pole 11.

The at least one first charging device 2 is mounted to the light pole 11 of the at least one street lamp module 1. The at least one first charging device 2 includes a wireless transmitting module 21, a micro-controller 22 and a detection module 23. Specifically, the wireless transmitting module 21 is mounted to a pole body 101 of the light pole 11. The micro-controller 22 is connected with the wireless transmitting module 21.

The detection module 23 is connected with the micro-controller 22. The detection module 23 is able to proceed with a wireless detection in a detection range. The detection module 23 is able to be used to detect whether the second charging device 3 is close to the first charging device 2.

When the second charging device 3 enters the detection range of the detection module 23, the detection module 23 will send a first signal to the micro-controller 22, and the micro-controller 22 will then send a second signal to activate the wireless transmitting module 21. After the second charging device 3 completes being charged, the wireless transmitting module 21 sends a third signal to the micro-controller 22, so that the micro-controller 22 makes the wireless transmitting module 21 enter a standby state. When the second charging device 3 leaves the detection range of the detection module 23, the detection module 23 sends a fourth signal to the micro-controller 22, so that the micro-controller 22 makes the wireless transmitting module 21 enter the standby state.

The second charging device 3 includes a wireless receiving module 31. The wireless receiving module 31 is able to receive energies from the wireless transmitting module 21 to proceed with a wireless charging. Specifically, the wireless receiving module 31 is attached to door glass of the electric vehicle 4 in a printing way. The wireless receiving module 31 is able to be detected by the detection module 23, so that the wireless transmitting module 21 wirelessly charges the wireless receiving module 31.

The wireless transmitting module 21 is in the standby state normally, and the detection module 23 continuously proceeds with the wireless detection within the detection range. When the electric vehicle 4 which is to be charged is close to the at least one street lamp module 1, the second charging device 31 of the electric vehicle 4 will enter the detection range of the detection module 23, so that the detection module 23 detects that the second charging device 31 is close to the at least one first charging device 2, and then the wireless transmitting module 21 is activated via the micro-controller 22 to wirelessly charge the wireless receiving module 31. When the smart street lamp charging system 100 includes a plurality of the street lamp modules 1 and a plurality of the first charging devices 2, the plurality of the first charging devices 2 are mounted under the plurality of the street lamp modules 1, the plurality of the first charging devices 2 include a plurality of the wireless transmitting modules 21, the rest of the wireless transmitting modules 21 of the plurality of the first charging devices 2 remains in the standby state.

When a plurality of the electric vehicles 4 which are to be charged are close to the plurality of the street lamp modules 1, the plurality of the electric vehicles 4 are equipped with a plurality of the second charging devices 3, the plurality of the second charging devices 3 are mounted at the bodies of the plurality of the electric vehicles 4, the plurality of the second charging devices 3 include a plurality of the wireless receiving modules 31, the second charging devices 31 of the plurality of the second charging devices 3 of the plurality of the electric vehicles 4 will enter the detection ranges of the detection modules 23 of the plurality of the first charging devices 2, so that the detection modules 23 of the plurality of the first charging devices 2 detect that the plurality of the second charging devices 3 approach the plurality of the first charging device 2. The detection modules 23 of the plurality of the first charging devices 2 transmit the first signals to the micro-controllers 22 of the plurality of the first charging devices 2, and the micro-controllers 22 of the plurality of the first charging devices 2 activate a corresponding quantity of the wireless transmitting modules 21 according to a current quantity of the electric vehicles 4 to pair with the wireless receiving modules 31 of the plurality of the electric vehicles 4, so that the wireless transmitting modules 21 of the corresponding quantity of the first charging devices 2 wirelessly charge the current quantity of the electric vehicles 4 which are paired with the corresponding quantity of the wireless transmitting modules 21. In this way, the plurality of the wireless receiving modules 31 are able to receive the energies from the plurality of the wireless transmitting modules 21, the plurality of the first charging devices 2 are able to simultaneously charge the plurality of the second charging devices 3.

When the electric vehicle 4 passes through the at least one street lamp module 1, the detection module 23 of the at least one first charging device 2 detects the wireless receiving module 31 of the second charging device 3, the wireless transmitting module 21 of the at least one first charging device 2 is activated to wirelessly charge the wireless receiving module 31 of the electric vehicle 4. Therefore, the at least one street lamp module 1 is able to wirelessly charge the electric vehicle 4 while the electric vehicle 4 is moving.

When the electric vehicle 4 passes through the plurality of the street lamp modules 1, the electric vehicle 4 is able to be wirelessly charged by the plurality of the street lamp modules 1 simultaneously in the path of the plurality of the street lamp modules 1.

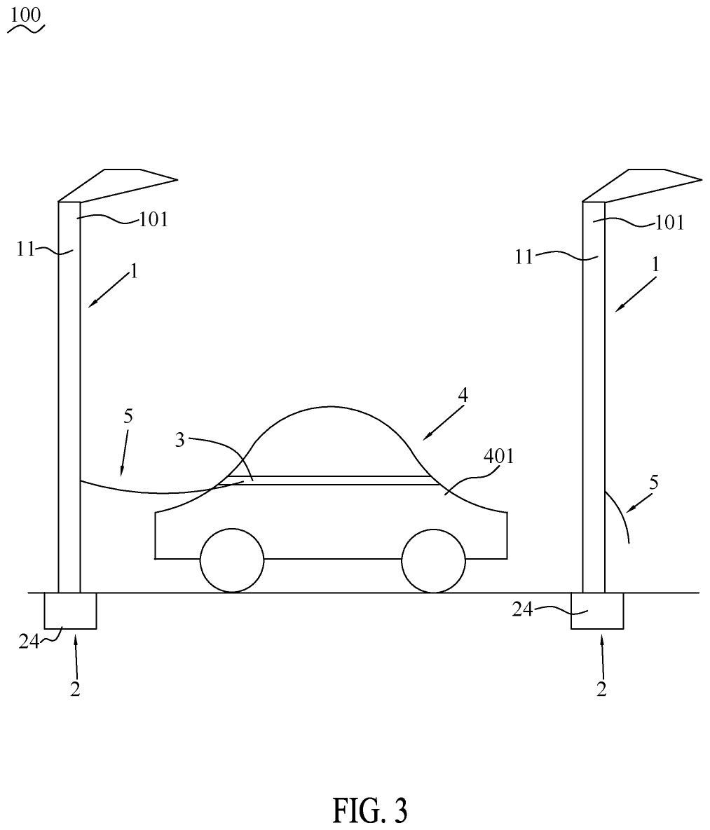

With reference to FIG. 3, the smart street lamp charging system 100 in accordance with a second preferred embodiment of the present invention is shown. In the second preferred embodiment, the at least one first charging device 2 is a super capacitor 24. The super capacitor 24 of the at least one first charging device 2 is mounted at a bottom of the light pole 11 of the at least one street lamp module 1.

The light pole 11 of the at least one street lamp module 1 includes a charging cable 5. The at least one first charging device 2 is connected with the charging cable 5. The charging cable 5 of the at least one street lamp module 1 is connected with the super capacitor 24 of the at least one first charging device 2 to transmit electric power of the super capacitor 24 of the at least one first charging device 2 to an outside.

The super capacitor 24 is an electrochemical element that stores the energies by means of polarizing electrolytes. The super capacitor 24 has characteristics of a long cycle use life, a high charging and discharging efficiency, a super discharge capacity, and a high energy conversion rate. Cycle use times of deep charging and discharging of the super capacitor 24 are able to reach 100000 to 500000 times, and the super capacitor 24 is without a memory effect. Therefore, the super capacitor 24 is suitable for an instant charging of the electric vehicle 4 with high electric power.

When the electric vehicle 4 which is to be charged is close to the at least one street lamp module 1, the second charging device 3 is able to connect with the charging cable 5, the charging cable 5 of the at least one street lamp module 1 is able to be connected to the second charging device 3 of the electric vehicle 4 by the user, so electric energies of the at least one first charging device 2 are transmitted to the second charging device 3 through the charging cable 5, and the super capacitor 24 of the at least one first charging device 2 quickly charges the second charging device 3 of the electric vehicle 4.

As described above, the smart street lamp charging system 100 charges the second charging device 3 mounted at the electric vehicle 4 by virtue of the at least one first charging device 2 being mounted to the at least one street lamp module 1, so that the instant charging of the electric vehicle 4 is realized. As a result, the smart street lamp charging system 100 is able to conveniently and instantly provide an additional power supply for the electric vehicle 4 to maintain an operation of the electric vehicle 4.

What is claimed is:

1. A smart street lamp charging system, comprising:
at least one street lamp module including a light pole;
at least one first charging device mounted to the light pole of the at least one street lamp module, the at least one first charging device including a wireless transmitting module; and
a second charging device mounted at a body of an electric vehicle, the second charging device including a wireless receiving module, the wireless receiving module being able to receive energies from the wireless transmitting module to proceed with a wireless charging.

2. The smart street lamp charging system as claimed in claim 1, wherein the at least one first charging device includes a micro-controller and a detection module, the micro-controller is connected with the wireless transmitting module, the detection module is connected with the micro-controller.

3. The smart street lamp charging system as claimed in claim 2, wherein when the second charging device enters a detection range of the detection module, the detection module will send a first signal to the micro-controller, and the micro-controller will then send a second signal to activate the wireless transmitting module, after the second charging device completes being charged, the wireless transmitting module sends a third signal to the micro-controller, so that the micro-controller makes the wireless transmitting module enter a standby state.

4. The smart street lamp charging system as claimed in claim 2, wherein when the electric vehicle passes through the at least one street lamp module, the detection module of the at least one first charging device detects the wireless receiving module of the second charging device, the wireless transmitting module of the at least one first charging device is activated to wirelessly charge the wireless receiving module of the electric vehicle, the at least one street lamp module is able to wirelessly charge the electric vehicle while the electric vehicle is moving.

5. The smart street lamp charging system as claimed in claim 1, wherein the wireless receiving module is attached to door glass of the electric vehicle in a printing way.

6. A smart street lamp charging system, comprising:
at least one street lamp module including a light pole, the light pole including a charging cable;
at least one first charging device mounted to the at least one street lamp module, the at least one first charging device being connected with the charging cable; and
a second charging device mounted at a body of an electric vehicle, the second charging device being able to connect with the charging cable, so electric energies of the at least one first charging device being transmitted to the second charging device through the charging cable.

7. The smart street lamp charging system as claimed in claim 6, wherein the at least one first charging device is a super capacitor.

8. The smart street lamp charging system as claimed in claim 6, wherein the at least one first charging device is mounted at a bottom of the light pole of the at least one street lamp module.

9. A smart street lamp charging system, comprising:
a plurality of street lamp modules;
a plurality of first charging devices mounted under the plurality of the street lamp modules, the plurality of the first charging devices including a plurality of wireless transmitting modules; and
a plurality of second charging devices mounted at bodies of a plurality of electric vehicles, the plurality of the second charging devices including a plurality of wireless receiving modules, the plurality of the wireless receiving modules being able to receive energies from the plurality of the wireless transmitting modules, the plurality of the first charging devices being able to simultaneously charge the plurality of the second charging devices.
